(19) United States
(12) Patent Application Publication
(10) Pub. No.: US 2021/0114346 A1
(43) Pub. Date: Apr. 22, 2021

(54) MULTILAYER FILM INCLUDING A NON-IONIC SURFACTANT AND USE THEREOF FOR A RECLOSABLE PACKAGING

(71) Applicant: BOSTIK SA, Colombes (FR)

(72) Inventors: Christophe ROBERT, Venette (FR); Romain PUCHOIS, Venette (FR)

(73) Assignee: BOSTIK SA, Colombes (FR)

(21) Appl. No.: 16/956,093

(22) PCT Filed: Dec. 10, 2018
(86) PCT No.: PCT/EP2018/084207

§ 371 Date: Jun. 19, 2020

(30) Foreign Application Priority Data
Dec. 19, 2017 (FR) 1762423

(51) Int. Cl. B32B 7/12; B32B 27/32; B32B 27/08; B32B 27/36; B32B 27/16; B65D 65/40; B32B 27/30; B32B 37/12; B32B 37/15

(52) U.S. Cl. CPC B32B 7/12; B32B 2037/1215; B32B 27/08; B32B 27/36; B32B 27/16; B65D 65/40; B32B 27/302; B32B 37/1207; B32B 37/153; B32B 2307/31; B32B 2553/00; B32B 2250/03; B32B 2250/24; B32B 2270/00; B32B 27/32

(57) ABSTRACT

1) Multilayer film comprising:
an adhesive layer A consisting of an extrudable hot-melt pressure-sensitive adhesive composition;
a hot-sealable and splittable layer B consisting of a composition b;
a complexable layer C consisting of a composition c;
   said film being characterized in that one of the compositions b and c is a composition t based on a thermoplastic material P comprising, on the basis of its total weight, from 0.1 to 5% by weight of a non-ionic surfactant T, the weight-average molar mass of which is less than 1000 g/mol and which comprises at least one saturated linear aliphatic chain containing from 10 to 22 carbon atoms.

2) Process for producing said film by co-extrusion.

3) Use of said film for producing reclosable packagings.

The subject of the present invention is a multilayer film comprising a layer consisting of an extrudable, hot-melt pressure-sensitive adhesive composition and a heat-sealable and splittable layer, a process for producing said film, and also the use thereof for producing reclosable packagings (or trays), intended in particular for the packaging of food products, in particular perishable food products.

Multilayer films comprising a layer consisting of an extrudable, hot-melt pressure-sensitive adhesive composition and a heat-sealable and splittable layer are known from applications WO 02/064694, WO 12/045950, WO 12/045951, WO 14/020243, EP2946920, EP2966140 and WO2017/013330. Such films are intended for use in the production of reclosable packagings (or trays).

The reclosable packagings, for example in the form of trays or bags, are used in the food-processing industry and large-scale distribution for packaging perishable food products, in particular fresh products. Such packagings are also described by patent EP 1 053 952.

After the packaging has been opened for the first time and a portion of the food product that it contains has been consumed, the consumer can manually reclose the packaging substantially hermetically and consequently as appropriate, after placing it in a refrigerator, store the remaining portion of the product. A sequence of reopenings and resealings is also possible.

These packagings generally comprise a container (or receptacle) and a seal forming a lid, which are hermetically attached to one another by heat welding (also denoted by the synonymous expression heat sealing).

The more or less deep and relatively rigid receptacle often consists of a multilayer sheet (also referred to as complex or composite sheet) having a minimum thickness of 200 μm, in general of between 200 and 1000 μm. This sheet is thermoformed so as to have a flat bottom on which the food product rests, and a perimeter in the form of a flat band. This perimeter, which is generally parallel to the bottom, is bonded by welding to the flexible and flat seal, which consists of a multilayer film (also described as complex or composite film) which has a thickness of generally between 40 and 150 μm, and which is sometimes denoted by the name sealing film.

During the opening of the packaging, the sealing film is manually separated from the receptacle at the flat band of the perimeter. This operation reveals an adhesive layer at this flat band, both on the sealing band and on the receptacle band which were previously in contact. These two (continuous or noncontinuous) adhesive layers, referred to as “daughters”, result from the rupturing of an initial or “mother” adhesive layer or, optionally, from its separation (or detachment) from one of the two layers of the complex film which are adjacent to it. The initial adhesive layer is therefore one of the layers of said complex film, denoted “layer A”. Said multilayer complex film is itself an element which may be included in the constituent composite sheet of the receptacle, but which is usually, in practice, included in the sealing film.

The two daughter adhesive layers that are present, after the packaging has been opened, on the bands located on the respective perimeter of the receptacle and of the seal are therefore facing one another. Thus, it is sufficient to reposition the seal on the receptacle, in accordance with their position in the packaging before opening, in order to bring the two bands of daughter adhesive layers back into contact. Simple manual pressure then makes it possible to obtain resealing of the packaging. The adhesive composition which constitutes the mother and daughter adhesive layers is thus necessarily a pressure-sensitive adhesive (PSA).

In addition to the extrudable hot-melt pressure-sensitive adhesive composition layer A, the complex films known from the prior art also comprise a heat-sealable and splittable layer B and a complexable layer C, the layer A ensuring the bonding between B and C.

The complexable layer C can be complexed (or laminated) with other layers for the production of the multilayer film, for example with a rigid layer for improving the mechanical strength of said film for the purpose of producing the seal of the packaging.

The heat-sealable (term synonymous with heat-weldable) and splittable layer B consists for example of a polyolefin, more particularly of polyethylene (PE) because of its heat-sealability at low temperature. When the layer B is included in the sealing film of the reclosable packaging, it is necessarily in contact with the atmosphere which surrounds the packaged article.

The heat-sealable and splittable layer B makes it possible to ensure:
during the packaging of the food product, the closing of the packaging by heat-welding of the sealing film on the receptacle, at the flat band of the perimeter, then
the first opening of the packaging carried out manually by the consumer, and obtained by rupturing the splittable zone which is located at the surface of B, at the flat band of the perimeter of the receptacle.

The performing of this first opening begins with the rupturing of said splittable zone, and then continues with the propagation of the rupturing along the adhesive layer A, until there is separation between the seal and the receptacle. This propagation takes place by rupturing the adhesive layer A in its body (termed cohesive rupture) and/or by rupturing the interface of said layer A with one and/or the other of the two adjacent layers B or C (termed adhesive rupture).

The ease of opening of the packagings consisting of the multilayer films previously described is closely linked to the properties of the PSA and more particularly to the force that must be applied, during the opening of the packaging (hereinafter referred to as first opening), in order to obtain the rupturing of the mother adhesive layer and/or the separation thereof from one of the 2 layers which are adjacent to it in the multilayer composite film mentioned above.

The capacity of the packaging to reclose and the quality of the reclosing obtained (hereinafter referred to as first reclosing) are important for having once again a substantially hermetic packaging which is therefore capable of ensuring the preservation of its contents. The quality of the first reclosing is also closely linked to the properties of the PSA. It is evaluated by the force that must be applied, during the reopening (hereinafter denoted as second opening), in order to obtain once again the rupturing and/or the detachment of the adhesive layer that was formed by the repositioning of the 2 daughter adhesive layers, followed by the manual pressure applied on the perimeter of the packaging.

Specifically, it currently appears to be increasingly necessary to improve the reclosing performance results of the reclosable packagings previously described, and to provide, in the context of the constant improvement of said packagings proposed to the consumer by the industry, new solutions for widening the possibilities from which said consumer can choose.

The objective of the present invention is therefore to provide a new multilayer film suitable for the production of reclosable packaging, which makes it possible—while at the same time maintaining easy first opening of the packaging—to improve the quality of the reclosing (or first reclosing) thereof, so as to assure the consumer that the remaining portion of the perishable food product will be preserved more effectively.

The objective of the invention is therefore also to increase the force of the second opening, and of the subsequent openings, while at the same time maintaining the force of the first opening at an acceptable level.

Another objective of the present invention is to provide a multilayer film which makes it possible to achieve the previous objectives at ambient temperature, corresponding to the temperature at which the consumer opens and recloses the packaging.

It has presently been found that these objectives can be totally or partly obtained by means of the multilayer film according to the invention which is described hereinafter.

A subject of the present invention is therefore first and foremost a multilayer film comprising:
an adhesive layer A having a thickness ranging from 7 to 50 μm and consisting of an extrudable hot-melt pressure-sensitive adhesive composition a which has a melt flow index (or MFI), measured for a temperature of 190° C. and a total weight of 2.16 kg, ranging from 0.01 to 200 g/10 minutes;
a hot-sealable and splittable layer B consisting of a composition b;
a complexable layer C consisting of a composition c;

the layers B and C being linked to one another by the layer A; and

said film being characterized in that one of the compositions b and c is a composition t based on a thermoplastic material P comprising, on the basis of its total weight, from 0.1 to 5% by weight of a non-ionic surfactant T, the weight-average molar mass of which is less than 1000 g/mol and which comprises at least one saturated linear aliphatic chain containing from 10 to 22 carbon atoms.

The use of such surfactants as an anti-fogging agent is known in the general field of flexible packaging. Indeed, it is common to observe, in the case of a packaging consisting of a transparent thermoplastic material and containing a food product, in particular a fresh product, the moisture content of which may be very high, the presence on the transparent exterior wall of the packaging of a mist originating from the condensation of the water that has evaporated from the packaged product. The formation of this mist or fogging has the effect of masking from the consumer the packaged article whether it is meat, flowers or vegetables, thus reducing the attractiveness of the packaged article and the possibility, in the case of a food product, to be sure, simply by observing it visually, of its quality for the purpose of its consumption.

The use of such a non-ionic surfactant as antifogging agent prevents this drawback. This is because it causes, at the surface of the layer of thermoplastic material into which it has been integrated, spreading of the droplets of water forming the opaque mist, so as to form an invisible film of water which does not impair the transparency of the exterior layer of the thermoplastic material.

It has presently been discovered, very surprisingly, that the incorporation of such a non-ionic surfactant into one of the layers B and C of the multilayer film which is the subject of the invention is also accompanied by a very significant improvement in the quality of the reclosing of the reclosable packaging obtained from said film, without notably deteriorating its ease of first opening.

Composition t:

The composition t based on a thermoplastic material P comprises, on the basis of its total weight, from 0.1 to 5% by weight of a non-ionic surfactant T, the weight-average molar mass of which is less than 1000 g/mol and which comprises at least one saturated linear aliphatic chain containing from 10 to 22 carbon atoms.

Preferably, the molar mass of T is less than 800 g/mol, more particularly less than 600 g/mol, and even more preferentially less than 500 g/mol.

According to one embodiment, the non-ionic surfactant T is a polyol esterified with at least one saturated linear fatty acid comprising from 10 to 22 carbon atoms, preferably from 12 to 18 carbon atoms.

According to one preferred embodiment, the non-ionic surfactant T is chosen from a sorbitan ester, a mono- or diglycerol ester and an ester of a poly(oxyethylene).

Particularly preferably, the non-ionic surfactant T is a sorbitan ester, and even more preferably a sorbitan monoester.

A sorbitan monoester of formula:

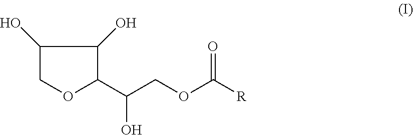

in which R is a linear alkyl radical comprising from 12 to 18 carbon atoms,

is most particularly preferred.

Such non-ionic surfactants are well known to those skilled in the art and widely commercially available.

A preferred range for the T content of the composition t is from 0.5 to 3%.

The thermoplastic material P is generally a thermoplastic polymer chosen from:
polyethylene (PE),
polypropylene (PP),
a copolymer based on ethylene and propylene,
polyamide (PA),
polyethylene terephthalate (PET), or else
a copolymer based on ethylene, for instance a maleic anhydride-grafted copolymer, a copolymer of ethylene and of vinyl acetate (EVA), a copolymer of ethylene and of vinyl alcohol (EVOH) or a copolymer of ethylene and of an alkyl acrylate, such as methyl acrylate (EMA) or butyl acrylate (EBA),
polystyrene (PS),
polyvinyl chloride (PVC),
polyvinylidene fluoride (PVDF),
a lactic acid polymer (PLA), or
a polyhydroxyalkanoate (PHA).

Among the thermoplastic polymers listed above, the following polymers are preferred: PE, PP, copolymer PE-PP, PA, PET, EVA, EVOH, EMA or EBA.

A polyolefinic material, and preferentially PE, and even more preferentially a low-density PE (LDPE), is more preferably used as thermoplastic material P.

The amount of thermoplastic material P included in the composition t is generally, on the basis of the total weight of said composition, at least 92% by weight, preferably at least 95%, possibly ranging up to 99.9%.

In addition to the non-ionic surfactant T and the thermoplastic material P, the composition t may optionally comprise additives commonly used in the flexible packaging field, such as plasticizers, coupling agents, viscosity-stabilizers, antioxidants, UV-absorbers, antistatic agents, dyes, pigments, mineral fillers. The total amount of these additives can range up to 3% by weight, on the basis of the total weight of t.

The composition t can be prepared by simply mixing the constituents thereof by hot extrusion. In practice, it can advantageously be prepared by dilution, in the thermoplastic material P, of masterbatches which themselves comprise the surfactant T uniformly distributed in the thermoplastic material P. Such masterbatches of T are commercially available, in particular based on PE, in the form of granules having a size identical to that of the PE granules with which they are mixed. The corresponding dilution is carried out by convenience in the context of the process for producing the multilayer film as described below in the present text.

Layers B and C:

The heat-sealable and splittable layer B and the complexable layer C consist respectively of the compositions b and c.

At least one of the compositions b and c is the composition t as defined above.

It is preferred for just one of the compositions b and c to be the composition t.

The layer which does not consist of the composition t consists of a thermoplastic material chosen from any one of the thermoplastic polymers of the list given above for P, it being identical to or different from said polymer, preferably identical. The composition of said layer may also comprise, as additives commonly used in the flexible packaging field, one or more of the additives listed above for the composition t, in an amount that can also range up to 3% by weight, on the basis of the total weight of t.

A polyolefinic material, and most particularly PE, and even more preferentially a low-density PE (LDPE), is preferably used as thermoplastic material for the layer which does not consist of the composition t.

According to one particularly preferred variant of the multilayer film according to the invention, the constituent composition b of the heat-sealable and splittable layer B is the composition t.

The complexable layer C can be complexed (or laminated) with other layers for the production of the packaging, for example with a rigid layer for producing the seal.

Layer A:

The adhesive layer A consists of an extrudable hot-melt pressure-sensitive adhesive composition a which has a melt flow index (or MFI), measured for a temperature of 190° C. and a total weight of 2.16 kg, ranging from 0.01 to 200 g/10 minutes.

The melt flow index (or MFI) is measured at 190° C. and for a total weight of 2.16 kg, in accordance with condition d) of the standard ISO 1133. The MFI is the weight of composition (previously placed in a vertical cylinder) that flows in 10 minutes through a die with a diameter of 2.095 nm, under the effect of a pressure exerted by a charged piston having the total weight of 2.16 kg. Unless otherwise mentioned, the MFI values indicated in the present text were measured under these same conditions.

The hot-melt pressure-sensitive adhesive compositions a having an MFI ranging from 2 to 70 g/10 minutes are more particularly preferred.

The hot-melt pressure-sensitive adhesive compositions are also commonly referred to as HMPSAs. They are substances which are solid at ambient temperature and which contain no water nor solvent. Applied in the molten state, they solidify as they cool thus forming an adhesive layer which provides the bonding between the 2 thin layers of thermoplastic polymeric material to be assembled, while at the same time providing the corresponding packaging with the advantageous opening and reclosing properties.

The composition a comprises, on the basis of the total weight of said composition a:
from 40% to 70% by weight of a composition a1 of styrene block copolymers comprising at least one elastomer block, said composition a1 consisting, on the basis of its total weight:
   of 30% to 90% by weight of at least one diblock copolymer chosen from the group comprising SI, SBI, SIB, SB, SEB and SEP, and
   of 10% to 70% by weight of at least one triblock copolymer chosen from the group comprising SIS, SIBS, SBS, SEBS and SEPS;

the total content of styrene units of said composition a1 ranging from 10% and 40% by weight on the basis of the total weight of a1; and
from 30% to 60% by weight of one or more tackifying resins a2.

The tackifying resins a2 used generally have a softening temperature of between 5 and 140° C.

The softening temperature (or point) is also denoted, in the adhesives field, by the expression “ring and ball softening point”, often abbreviated to R & B.

This temperature is determined in accordance with the standardized ASTM E 28 test, the principle of which is the following. A brass ring with a diameter of approximately 2 cm is filled with the resin to be tested, in the molten state. After cooling to ambient temperature, the ring and the solid resin are placed horizontally in a thermostated glycerol bath, the temperature of which can vary by 5° C. per minute. A steel ball with a diameter of approximately 9.5 mm is centred on the disc of solid resin. The softening temperature is, during the phase of rise in the temperature of the bath at a rate of 5° C. per minute, the temperature at which the solid resin disc, after it has passed into the viscous fluid state, yields by a height of 25.4 mm under the weight of the ball.

Composition a1:

The composition a1 which is included in the constituent HMPSA composition a of the adhesive layer A comprises one or more styrene block copolymers, having a weight-average molar mass Mw of generally between 50 kDa and 500 kDa.

These styrene block copolymers consist of blocks of various polymerized monomers including at least one polystyrene block, and are prepared by radical-polymerization techniques.

Unless otherwise indicated, the weight-average molar masses M_{w} that are given in the present text are expressed in daltons (Da) and are determined by Gel Permeation Chromatography, the column being calibrated with polystyrene standards.

The triblock copolymers include 2 polystyrene blocks and 1 elastomer block. They can have various structures: linear, star (also called radial), branched or else comb. The diblock copolymers include 1 polystyrene block and 1 elastomer block.

The triblock copolymers have the general formula:

ABA (I)

in which:
A represents a styrene (or polystyrene) non-elastomer block, and
B represents an elastomer block which may be:
   polyisoprene. The block copolymer then has the structure: polystyrene-polyisoprene-polystyrene and has the name: SIS;
   polyisoprene followed by a polybutadiene block. The block copolymer then has the structure: polystyrene-polyisoprene-polybutadiene-polystyrene and has the name: SIBS;
   polybutadiene. The block copolymer then has the structure: polystyrene-polybutadiene-polystyrene and has the name: SBS;
   totally or partially hydrogenated polybutadiene. The block copolymer then has the structure: polystyrene-poly(ethylenebutylene)-polystyrene and has the name: SEBS;
   totally or partially hydrogenated polyisoprene. The block copolymer then has the structure: polystyrene-poly(ethylenepropylene)-polystyrene and has the name: SEPS.

The diblock copolymers have the general formula:

A-B (II)

in which A and B are as defined previously.

When the composition a1 comprises several triblock styrene copolymers, the latter being chosen from the group comprising SIS, SBS, SEPS, SIBS and SEBS, it is clearly understood that said triblocks can belong to just one or to several of these 5 copolymer families. The same is true, mutatis mutandis, for the diblock copolymers.

It is preferred to use a composition a1 comprising a triblock copolymer and a diblock copolymer having the same elastomer block, owing in particular to the fact that such blends are commercially available.

According to one particularly preferred implementation variant, the content of diblock copolymer in the composition a1 can range from 40% to 90%, preferably from 50% to 90%, even more preferentially from 70% to 90%.

According to one particularly advantageous embodiment of the constituent composition a of the layer A included in the multilayer film according to the invention, the composition a1 consists of an SIS triblock copolymer and of an SI diblock copolymer. In this case, the total content of styrene units in the composition a1) preferably ranges from 10% to 20%.

The triblock copolymers included in the composition a1 preferably have a linear structure.

The styrene block copolymers comprising an elastomer block, in particular of SI and SIS type, that can be used in the composition a) are commercially available, often in the form of triblock/diblock blends.

Kraton® D1113BT from the company Kraton and Quintac® 3520 from the company Zeon Chemicals are examples of compositions a1 consisting of SIS and SI.

Kraton® D1113BT is a composition of which the overall content of styrene units is 16%, and which consists of 45% of linear SIS triblock copolymer of M_{w} approximately 250 kDa, and 55% of SI diblock copolymer of M_{w} approximately 100 kDa. Quintac® 3520 is a composition which consists, respectively, of 22% and of 78% of linear SIS triblock (M_{w} approximately 300 kDa) and of SI diblock (M_{w} approximately 130 kDa), and the total content of styrene units of which is 15%.

Tackifying Resins a2:

The constituent HMPSA composition a of the layer A also comprises one or more tackifying resins a2 having generally a softening temperature of between 5 and 140° C.

The tackifying resin(s) a2 that can be used have weight-average molar masses M_{w} of generally between 300 and 5000 Da and are chosen in particular from:
(i) rosins of natural origin or modified rosins, such as, for example, the rosin extracted from pine gum, wood rosin extracted from tree roots and derivatives thereof which are hydrogenated, dehydrogenated, dimerized, polymerized or esterified with monoalcohols or polyols, such as glycerol;
(ii) resins obtained by hydrogenation, polymerization or copolymerization (with an aromatic hydrocarbon) of mixtures of unsaturated aliphatic hydrocarbons having approximately 5, 9 or 10 carbon atoms resulting from petroleum fractions;
(iii) terpene resins generally resulting from the polymerization of terpene hydrocarbons, such as, for example, monoterpene (or pinene), in the presence of Friedel-Crafts catalysts, which are optionally modified by the action of phenols;
(iv) copolymers based on natural terpenes, for example styrene/terpene, α-methylstyrene/terpene and vinyltoluene/terpene.

According to one preferred variant, use is made of aliphatic resins belonging to categories (ii) or (iii) for which mention may be made, as examples of commercially available resin, of:

(ii) Escorez® 1310 LC available from Exxon Chemicals, which is a resin obtained by polymerization of a mixture of unsaturated aliphatic hydrocarbons having approximately 5 carbon atoms, and which has a softening temperature of 94° C. and a M_{w} of approximately 1800 Da; Escorez® 5400 also from the company Exxon Chemicals, which is a resin obtained by polymerization then hydrogenation of a mixture of unsaturated aliphatic hydrocarbons having approximately 9 or 10 carbon atoms and which has a softening temperature of 100° C. and a M_{w} of approximately 570 Da; Regalite™ R1125, available from the company Eastman, which is a totally hydrogenated resin having a softening temperature of 125° C., a weight-average molar mass M_{w} of 1200 Da, and which is obtained by polymerization of a composition of unsaturated hydrocarbons having 9 carbon atoms;

(iii) Dercolyte® 5115 available from Dérivés Résiniques et Terpéniques (or DRT), which is a terpene resin having a softening temperature of 115° C. and a M_{w} of approximately 2300 Da.

According to one preferred variant, the constituent HMPSA composition a of the layer A essentially consists of:
from 40% to 70% of the composition a1 of styrene block copolymers; and
from 30% to 60% of at least one tackifying resin a2 having a softening temperature of between 5 and 140° C.

According to another preferred variant, the constituent HMPSA composition a of the layer A comprises or essentially consists of:
from 50% to 70% of the composition a1 of styrene block copolymers; and
from 30% to 50% of at least one tackifying resin a2 having a softening temperature of between 5 and 140° C.

According to yet another preferred variant, the constituent HMPSA composition a of the layer A can also comprise, in addition to the composition a1 and the tackifying resin(s) a2, from 0.1% to 2% of one or more stabilizers (or antioxidants). These compounds are introduced in order to protect the composition from degradation resulting from a reaction with oxygen which is liable to be formed by the action of heat, light or residual catalysts on certain starting materials, such as the tackifying resins. These compounds can include primary antioxidants, which trap free radicals and are generally substituted phenols, such as Irganox® 1010 from Ciba. The primary antioxidants can be used alone or in combination with other antioxidants, such as phosphites, for instance Irgafos® 168 also from Ciba, or else with UV-stabilizers such as amines.

The composition a can also comprise a plasticizer, but in an amount not exceeding 5%. As plasticizer, use may be made of a paraffinic and naphthenic oil (such as Primol® 352 from the company ESSO) optionally comprising aromatic compounds (such as Nyflex 222B).

Finally, the composition a can comprise mineral or organic fillers, pigments or dyes.

The adhesive composition a can be prepared, in the form of granules having a size between 1 and 10 mm, preferably between 2 and 5 mm, by simple hot-mixing of its ingredients, between 150 and 200° C., preferably at approximately 160° C., by means of a twin-screw extruder equipped with a tool for cutting the extruded product as it leaves the die.

In addition to the layers A, B and C, the multilayer film according to the invention can also comprise other layers required for preparing the packaging, for instance:
an intermediate layer (also described as tie) D, connecting the layer A to the layer B, and/or a tie layer E, connecting the layer A to the layer C, or
a rigid layer required for the mechanical strength of the receptacle, or
a printable layer, or else
a layer with a barrier effect against oxygen, water vapour or else carbon monoxide.

The tie layers D and E consist of identical or different compositions of polymers. Said polymers are generally chosen from polyethylene homopolymers or copolymers, polypropylene homopolymers or copolymers, copolymers of ethylene and polar comonomers, or else grafted polyolefin copolymers. For greater detail regarding the composition of the tie layers, reference is made to document US 2013/0029553.

The materials that can be used to form the optional other layers may be identical or different and generally comprise thermoplastic polymers which can be chosen from the polymers mentioned above for the layer B or the layer C.

The thickness of the layer A can range, preferably, from 8 to 25 μm, even more preferentially from 10 to 20 μm.

The thickness of the tie layers D and E is, for its part, generally between 1 and 10 μm, and preferably between 2 and 8 μm.

The thickness of the 2 layers B and C, and also of the other layers optionally used in the multilayer film according to the invention, is capable of varying within a wide range of from 5 to 150 μm.

According to one implementation variant, the multilayer film according to the invention is a film comprising 5 layers consisting of the adhesive layer A, the 2 intermediate layers D and E and the 2 external layers B and C, according to the sequence B/D/A/E/C in which the “/” sign signifies that the faces of the layers in question are in direct contact.

According to another implementation variant, the multilayer film according to the invention is a film comprising 3 layers consisting of the adhesive layer A and the 2 external layers B and C, according to the sequence B/A/C.

The present invention also relates to a process for producing the multilayer film as defined previously, characterized in that it comprises the co-extrusion of the hot-melt pressure-sensitive adhesive composition a and of the compositions b and c, at a temperature of between 150° C. and 260° C.

According to one variant of said process, the co-extrusion is carried out by using a rectangular die.

According to one preferred variant, the co-extrusion is carried out by means of a blow-moulding process (also referred to as bubble blowing), said process comprising:
(i) the introduction, into separate extruders, of the constituent compositions and materials of the layers A, B, C, and where appropriate D and E, in the form of granules having a size of between 1 and 10 mm, preferably between 2 and 5 mm, then
(ii) the conversion by heating of said granules to the viscous liquid state, then
(iii) the passing of the corresponding streams through an extrusion head comprising a set of coplanar and concentric annular dies, each brought to a temperature below 260° C., so as to form a tubular bubble comprising several layers, in which the order of the layers corresponds to that desired for the final film, then
(iv) the radial (relative to the plane of the annular dies) expansion and the drawing (in the direction perpendicular to said plane) of the bubble, then
(v) the cooling of said bubble.

In step (i), the introduction into each extruder of a constituent composition (or material) of one of the layers of the film is advantageously carried out by means of a main hopper. When the corresponding composition is the composition t, the introduction of the thermoplastic material P and of the small amount of masterbatch of the surfactant T is carried out by means of secondary hoppers. The required amounts are adjusted by means of gravimetric metering devices. Thus, the constituent composition t of one of the layers B or C is produced homogeneously.

The geometrical characteristics of the dies, like the parameters of the process, such as the degree of radial expansion and the drawing speed, are set so as to obtain the desired thickness for the various constituent layers of the multilayer film. For a more thorough description of the co-extrusion bubble blowing process, reference is in particular made to patent application US 2013/0029553.

According to one preferred variant of the process according to the invention, the extrusion head used in step (iii) is a monoblock extrusion head, in which the annular dies are brought to one and the same temperature below 260° C. Advantageously, such extrusion heads equip the vast majority of the co-extrusion blow-moulding devices available on the market, thus making the process easier to implement.

Preferably, the co-extrusion temperature varies within a range of from 170 to 200° C.

The present invention also relates to the use of the multilayer film as described above, for producing reclosable packagings.

The use for producing reclosable trays is particularly advantageous, and according to one particularly preferred embodiment for producing the sealing film of these trays.

The examples that follow are given purely by way of illustration of the invention and should not in any way be interpreted in order to limit the scope thereof.

### EXAMPLE A (REFERENCE): EXTRUDABLE HOT-MELT PRESSURE-SENSITIVE ADHESIVE COMPOSITION

A composition consisting, on the basis of % weight/weight, of 59.8% of Quintac® 3520, 39.7% of Regalite™ R1125 and 0.5% of Irganox® 1010 is prepared in the form of a viscous liquid, by simply mixing the ingredients at 160° C. by means of a twin-screw extruder equipped with a tool for cutting the extruded product at the die outlet, in the form of granules.

An MFI of 30 g/10 minutes is measured.

### EXAMPLE B (REFERENCE): THREE-LAYER FILM BAC COMPRISING A LAYER A CONSISTING OF THE COMPOSITION OF EXAMPLE A AND A HEAT-SEALABLE AND SPLITTABLE LAYER B CONSISTING OF LDPE

This three-layer film is produced by means of a continuously operating co-extrusion bubble blowing pilot-scale device equipped with a monoblock extrusion head brought to a temperature of 190° C., in which device 3 extruders are fed in the following way:
one is fed with the composition of Example A, and
the other two are fed with low-density polyethylene (or LDPE);
   the 3 compositions being in the form of granules having a size of approximately 4 mm.

The process parameters are adjusted so as to produce a three-layer film consisting:
as layer A, of a layer with a thickness of 15 μm consisting of the extrudable hot-melt pressure-sensitive adhesive composition of Example A,
as heat-sealable and splittable layer B, of a layer with a thickness of 15 μm consisting of LDPE.
as complexable layer C, of a layer with a thickness of 30 μm also consisting of LDPE.

Among the parameters usually set, mention may be made of a degree of radial expansion of the bubble equal to 3, a drawing speed of 7 m/minute and an overall throughput of 11 kg/hour.

The three-layer film thus obtained has a total thickness of 60 μm and a length of 50 m and is packaged in the form of a reel with a machine width of 250 mm.

It is subjected to tests B.1. and B.2. described below.

B.1. Measurement of the First-Opening Force by Peeling in T at 23° C.:

A sample in the form of a rectangular sheet with A4 format (21×29.7 cm) is cut out from the three-layer film thus obtained.

The external face of the complexable layer C of this sample is:
in a first step, subjected to a corona surface treatment (by means of a plasma), then
in a second step, complexed (in other words laminated) on a PET film having a thickness of 23 μm by means of a polyurethane-based solvent-based adhesive and using a coating device of the Mayer bar type.

The rectangular sheet is then placed under pressure for 24 h.

Said rectangular sheet is then folded along a line located in its middle and parallel to the small side of the rectangle, which results in the sealable and splittable layer B being brought into contact with itself.

Partial sealing is then carried out using two heating clamping jaws at 130° C. applied under a pressure of 6 bar for 1 second, so as to obtain sealed regions of rectangular shape (8 cm in length and 1 cm in width) arranged perpendicularly to the line of folding. Each sealed zone is cut to obtain a tensile test specimen in which the sealed zone 8 cm in length is extended (to that of its ends which is opposite the line of folding) by 2 bands approximately 2 cm in length, left free and non-sealed.

These two free bands are attached to two holding devices (known as jaws) respectively connected to a stationary part and a movable part of a tensile testing device, which are located on a vertical axis. This tensile testing device is a dynamometer.

While a drive mechanism imparts a uniform rate of 300 mm/minute to the movable part, resulting in the peeling of the 2 sealed layers, the ends gradually move along a vertical axis with the formation of an angle of 180°. A force sensor connected to said movable part measures the force withstood by the test specimen thus held. The measurement is carried out in a climate-controlled room maintained at a temperature of 23° C.

The force obtained is 5.7 N/cm.

B.2. Measurement of the Second-Opening Force by Peeling in T at 23° C.:

The 2 parts of the preceding test specimen are, after peeling, repositioned facing one another and brought into contact manually. They are then subjected to a pressure exerted by means of a roller with a weight of 2 kg, with which a to-and-fro movement is carried out in a direction parallel to the length of the test specimen.

A tensile test specimen is thus obtained which is identical in shape to that prepared for the preceding peeling test, which is then repeated.

The force obtained is 1.8 N/cm.

### EXAMPLE 1 (ACCORDING TO THE INVENTION): THREE-LAYER FILM BAC COMPRISING A LAYER A CONSISTING OF THE COMPOSITION OF EXAMPLE A AND A HEAT-SEALABLE AND SPLITTABLE LAYER B CONSISTING OF 99.5% OF LDPE AND 0.5% OF A SORBITAN ESTER

Example B is repeated by replacing, for the heat-sealable and splittable layer B, the LPDE as exclusive constituent of the layer with a composition consisting of 99.5% of LDPE and 0.5% of a sorbitan monoester corresponding to formula (I) defined above.

The latter composition is obtained by mixing granules of LDPE having a size of approximately 4 mm with 5% by weight of granules of the same size of a premix of 10% of the sorbitan ester and 90% of LDPE.

Such a premix is commercially available as an anti-fogging agent under the name Polybatch AF 1082 from the company A. Schulman

A 1^{st}-opening force equal to 6.7 N/cm and a 2^{nd}-opening force equal to 3.6 N/cm are obtained.

### EXAMPLE 2 (ACCORDING TO THE INVENTION): THREE-LAYER FILM BAC COMPRISING A LAYER A CONSISTING OF THE COMPOSITION OF EXAMPLE A AND A HEAT-SEALABLE AND SPLITTABLE LAYER B CONSISTING OF 99% OF LDPE AND 1% OF A SORBITAN ESTER

Example 1 is repeated by incorporating 10% by weight of granules of the sorbitan ester premix, so as to obtain a heat-sealable and splittable layer B consisting of 99% of LDPE and 1% of sorbitan ester.

A 1^{st}-opening force equal to 6.8 N/cm and a 2^{nd}-opening force equal to 4.1 N/cm are obtained.

It is noted that the 2^{nd}-opening force of the film of Examples 1 and 2 is greater by a factor of two than the 2^{nd}-opening force of the film of Comparative Example B, thereby demonstrating a very significant improvement in the closing capacity of the film according to the invention. This improvement in the closing capacity of the film is obtained with a 1^{st}-opening force which does not notably increase, and is characterized by easy opening of the corresponding reclosable packaging.

1. Multilayer film comprising:
an adhesive layer A having a thickness ranging from 7 to 50 μm and consisting of an extrudable hot-melt pressure-sensitive adhesive composition a which has a melt flow index (or MFI), measured for a temperature of 190° C. and a total weight of 2.16 kg, ranging from 0.01 to 200 g/10 minutes;
a hot-sealable and splittable layer B consisting of a composition b;
a complexable layer C consisting of a composition c;
the layers B and C being linked to one another by the layer A; and
said film being characterized in that one of the compositions b and c is a composition t based on a thermoplastic material P comprising, on the basis of its total weight, from 0.1 to 5% by weight of a non-ionic surfactant T, the weight-average molar mass of which is less than 1000 g/mol and which comprises at least one saturated linear aliphatic chain containing from 10 to 22 carbon atoms.

2. Multilayer film according to claim 1, characterized in that the non-ionic surfactant T is a polyol esterified with at least one saturated linear fatty acid comprising from 10 to 22 carbon atoms.

3. Multilayer film according to claim 1, characterized in that the non-ionic surfactant T is chosen from a sorbitan ester, a mono- or diglycerol ester and an ester of a poly(oxyethylene).

4. Multilayer film according to claim 1, characterized in that the non-ionic surfactant T is a sorbitan monoester of formula: 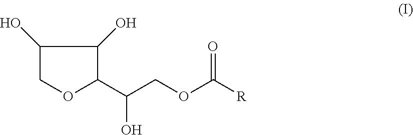
in which R is a linear alkyl radical comprising from 12 to 18 carbon atoms.

5. Multilayer film according to claim 1, characterized in that the thermoplastic material P is a polyolefinic material which is included in the composition tin a proportion of an amount of at least 92% by weight, on the basis of the total weight of said composition.

6. Multilayer film according to claim 1, characterized in that the constituent composition b of the heat-sealable and splittable layer B is the composition t.

7. Multilayer film according to claim 1, characterized in that the composition a of the adhesive layer A comprises, on the basis of the total weight of said composition a:
from 40% to 70% by weight of a composition a1 of styrene block copolymers comprising at least one elastomer block, said composition a1 consisting, on the basis of its total weight:
of 30% to 90% by weight of at least one diblock copolymer chosen from the group comprising SI, SBI, SIB, SB, SEB and SEP, and
of 10% to 70% by weight of at least one triblock copolymer chosen from the group comprising SIS, SIBS, SBS, SEBS and SEPS;
the total content of styrene units of said composition a1 ranging from 10% to 40% by weight on the basis of the total weight of a1; and
from 30% to 60% by weight of one or more tackifying resins a2.

8. Multilayer film according to claim 1, characterized in that the adhesive layer A has a thickness ranging from 8 to 25 μm.

9. Multilayer film according to claim 1, characterized in that it also comprises a tie layer D, connecting the layer A to the layer B, and/or a tie layer E, connecting the layer A to the layer C.

10. Process for producing the multilayer film as defined in claim 1, characterized in that it comprises the co-extrusion of the hot-melt pressure-sensitive adhesive composition a and of the compositions b and c, at a temperature of between 150° C. and 260° C.

11. Process for producing the multilayer film according to claim 10, characterized in that the co-extrusion is carried out by means of a blow-moulding process, said process comprising:
(i) the introduction, into separate extruders, of the constituent compositions and materials of the layers A, B, C, and where appropriate D and E, in the form of granules having a size of between 1 and 10 mm, preferably between 2 and 5 mm, then
(ii) the conversion by heating of said granules to the viscous liquid state, then
(iii) the passing of the corresponding streams through an extrusion head comprising a set of coplanar and concentric annular dies, each brought to a temperature below 260° C., so as to form a tubular bubble comprising several layers, in which the order of the layers corresponds to that desired for the final film, then
(iv) the radial (relative to the plane of the annular dies) expansion and the drawing (in the direction perpendicular to said plane) of the bubble, then
(v) the cooling of said bubble.

12. Use of the multilayer film as defined in one of claims 1 to 9, for producing reclosable packagings.
